(19) United States
(12) Patent Application Publication
(10) Pub. No.: US 2020/0095431 A1
(43) Pub. Date: Mar. 26, 2020

(54) A FORMULATION AND A COATED SUBSTRATE

(71) Applicant: SVENSKA AEROGEL AB, Gävle (SE)

(72) Inventors: Göran HEDMAN, Smedjebacken (SE); Farnaz GHAJERI, Gävle (SE)

(73) Assignee: SVENSKA AEROGEL AB, Gävle (SE)

(21) Appl. No.: 16/618,662

(22) PCT Filed: Jun. 4, 2018
(86) PCT No.: PCT/SE2018/050574

§ 371 Date: Dec. 2, 2019

(30) Foreign Application Priority Data
Jun. 5, 2017 (SE) 1750711-2

(51) Int. Cl. C09D 5/02; C09D 1/02; C09D 109/08; B41M 5/52

(52) U.S. Cl. CPC C09D 5/028; B41M 5/52; C09D 109/08; C09D 1/02

(57) ABSTRACT

A formulation for forming an ink-receptive coating on a substrate includes more than 1 percent by weight (wt. %) of dry matter of a mesoporous material including particles of precipitated silica, wherein the mesoporous material is incorporated in the formulation in the form of a paste having a water content within a range of 60-95 wt. %, wherein the paste has been obtained by washing and dewatering of a slurry formed by mixing alkali silicate with a salt solution so that coagulation occurs.

### TECHNICAL FIELD

The present invention relates to a formulation for forming an ink-receptive coating on a substrate intended for printing using a printing device, exemplified by but not limited to an ink-jet printing device, a high-speed ink-jet machine, or a printing device for offset printing, rotogravure, or flexo printing (flexography). It also relates to an ink-receptive coated substrate, exemplified by but not limited to a paper sheet, a method of forming an ink-receptive coated substrate, and use of a formulation for forming an ink-receptive coating.

The substrate may e.g. be in the form of a cellulose paper based on virgin or recycled fibers or a mixture thereof, glass-mat, a synthetic paper, a non-woven fabric, a plastic film or a pre-coated substrate. The substrate may be pigmented.

### BACKGROUND AND PRIOR ART

In ink-jet printing applications, a coating for receiving ink is typically applied on a substrate intended for printing in order to improve image quality. It is common to use a porous coating comprising an inorganic filler, a binder, a thickener and possibly other additives. The porosity of the coating allows rapid diffusion of ink into the coating since it provides capacity for liquid uptake.

Current efforts are aimed at improving productivity of ink-jet printing processes without impairing the quality of the printed material. Likewise, efforts are made to improve the printing quality in terms of print sharpness, such as blurriness, line thickness and feathering, without negatively affecting the printing density.

### SUMMARY OF THE INVENTION

It is a primary object of the present invention to achieve an in at least some aspect improved formulation for forming an ink-receptive coating on a substrate. In particular, it is an objective to achieve such a coating which allows rapid adsorption of ink with improved printing quality and increased productivity as a result thereof, preferably without significantly impairing printing density.

According to a first aspect of the invention, at least the primary objective is achieved by means of the formulation defined in claim 1. The formulation comprises more than 1 percent by weight (wt. %) of dry matter of a mesoporous material comprising particles of precipitated silica, wherein the mesoporous material is incorporated in the formulation in the form of a paste having a water content within a range of 60-95 wt. %, wherein the paste has been obtained by washing and dewatering of a slurry formed by mixing alkali silicate with a salt solution so that coagulation occurs.

The particles of precipitated silica present in the paste have not been dried prior to incorporation in the formulation, since the paste has been obtained by washing and dewatering of the slurry formed in the precipitation process. The particles in the paste therefore have their original volume when the formulation is applied on the substrate. The particles have not been subjected to previous drying and therewith associated shrinking, which is known to result in that the particles cannot regain their original volume, even if a liquid is added to the dried particles.

With the mesoporous material included in the formulation in the form of the paste with the relatively high water content and in which the particles have not been previously dried, microcracks are created in the coating as it dries after application and the particles of precipitated silica shrink. The microcracks contribute to a rapid adsorption of ink, preventing lateral diffusion on the substrate. The microcracks thereby result in an improved printing quality, enabling high-resolution printing with reduced line thickness and raggedness. Furthermore, the printing machine can be run at a higher speed without impairing the printing quality, thus increasing the productivity.

Preferably, the formulation has a dry matter content of less than 60 wt. %.

According to one embodiment, the mesoporous material is present in the formulation in an amount of 2-15 wt. % of dry matter, preferably in an amount of 3-12 wt. %, more preferably in an amount of 4-10 wt. %. In particular, an amount of 4-6 wt. % of mesoporous material has been found to be beneficial for the formation of microcracks in the coating.

According to one embodiment, the particles of precipitated silica correspond to the formula Me_{y}O×m SiO₂, wherein Me denotes any two or more metals selected among Ca, Mg, Cu, Zn, Mn, Cd, Pb, Ni, Fe, Cr, Al, Ti, V, Co, Mo, Sn, Sb, Sr, Ba and W, y denotes the molar ratio of metallic constituents to oxygen, and m denotes the molar ratio of SiO₂/Me_{y}O. A method of manufacturing such an amorphous precipitated silica material has been previously described in WO2006/071183. The precipitated silica material according to this formula is known to have a relatively large BET surface area and can be manufactured with suitable pore sizes within the mesoporous range, i.e. 2-50 nm and suitable particle sizes. The value of m may vary between 1-4, or preferably 2-3.7, such as m=3.35. The value of y may vary within the range 0.5-2, depending on the valences of the metals. Impregnating agents may also be added to the precipitated silica material.

According to one embodiment, Me denotes Ca and/or Mg. The molar ratio of Ca/Mg may e.g. be 35/65 or 32/68, but the molar ratio may of course be optimised to achieve desired properties in terms of e.g. particle size. Preferably, the molar ratio of Ca/Mg varies within the range 0.05<Ca/Mg<1.0. The particles of precipitated silica may be in the form of a Quartzene® material of CMS type, which can be written as (Ca_{0.35},Mg_{0.65})O×3.35 SiO₂, i.e. Me=(Ca_{0.35},Mg_{0.65}), y=1 and m=3.35.

According to one embodiment, the paste has a water content within a range of 70-95 wt. %. Within this range, the conditions for formation of microcracks are improved. The water content can be adjusted within the range to control shrinking of the coating and thereby the number of microcracks in the final coating.

According to one embodiment, a particle size distribution of the particles of precipitated silica has a particle size D90 value of less than 5 μm, preferably of less than 3 μm and more preferably of less than 2 μm. In other words, at least 90% of the particles have a diameter of less than 5 μm, preferably 3 μm and more preferably 2 μm. Preferably, at least 99% of the particles have a diameter of less than 12 μm. The desired relatively small particle size can be achieved by ultrasound treatment of the paste prior to incorporating the paste with other constituents of the formulation. The ultrasound treatment reduces the particle size and is therefore beneficial for achieving an even surface suitable for high quality printing.

According to one embodiment, the particle size distribution has a particle size D50 value of less than 1 μm, preferably of less than 0.5 μm and more preferably of less than 0.45 μm. This is preferably achieved by ultrasound treatment as described above.

According to one embodiment, the formulation further comprises:
an inorganic filler,
a binder in the form of a polymer,
a thickener,
optionally one or more additives selected among dispersants, antifoaming agents, biocides, co-binders and colorants.

The inorganic filler may be one or more of calcium carbonate, titanium dioxide, kaolinite, talc, gypsum, calcined kaolin, or other fillers commonly used in the field.

The binder may be one or more of polyvinyl alcohol, synthetic latex such as styrene-butadiene latex, styrene-acrylate latex, and/or polyvinyl acetate latex, acrylic resins, cellulose derivatives, carboxymethyl cellulose (CMC), starch, protein, or other binders commonly used in the field.

The thickener, or viscosity modifier, may be one or more of CMC, starch, soy protein, casein, alginate, hydroxyethyl cellulose, acrylic polymers, or other thickeners commonly used in the field.

According to one embodiment, the binder is present in an amount of 2-20 wt. % of dry matter.

According to one embodiment, the thickener is present in an amount of 0.5-5 wt. % of dry matter.

According to one embodiment, the inorganic filler is present in an amount of 75-95 wt. % of dry matter.

With binder, filler and thickener within the mentioned ranges, a coating suitable for high quality printing can be achieved.

According to another aspect of the invention, it is an objective to achieve an in at least some aspect improved substrate for printing. This objective is achieved by an ink-receptive coated substrate, comprising:
a substrate,
an ink-receptive coating formed on the substrate, wherein the coating has been formed by applying the proposed formulation onto a surface of the substrate.

The substrate may preferably be in the form of a paper sheet based on virgin or recycled fibers or a mixture thereof, more preferably a paper sheet comprising or being entirely formed from virgin fibres. The substrate may also be provided with a pre-coating applied before application of the ink-receptive coating. Advantages and advantageous features of such a coated substrate appear from the above description of the proposed formulation.

According to one embodiment, the coating comprises microcracks having a width of less than 10 μm, preferably of less than 5 μm, more preferably of less than 3 μm. The microcracks preferably have a width of at least 0.5 μm. A size of the order of 1 μm has been found to be beneficial for the quick adsorption of ink.

According to one embodiment, the coating is present on the substrate in an amount of 1.0-20 g/m², preferably 1.0-15 g/m², more preferably 1.5-12 g/m², wherein the amount is expressed in terms of dry matter. This results in a suitable thickness of the coating.

According to another aspect of the invention, it is an objective to achieve an in at least some aspect improved method of forming a substrate for printing. This is achieved by a method of forming an ink-receptive coated substrate, comprising:
providing a substrate,
forming an ink-receptive coating on the substrate by applying the proposed formulation onto a surface of the substrate and subsequently drying the applied formulation.

Advantages and advantageous features of such a method appear from the above description of the proposed formulation.

The invention further relates to use of the proposed formulation for forming an ink-receptive coating on a substrate.

Further advantages as well as advantageous features of the present invention will appear from the following detailed description.

### BRIEF DESCRIPTION OF THE DRAWINGS

Embodiments of the invention will in the following be described with reference to the appended drawings, in which:

FIG. 1 shows particle size distributions of a mesoporous material used in a formulation according to an embodiment of the invention,

FIG. 2 shows contact angle with water as a function of time for different coated substrates,

FIG. 3 shows contact angle with cyan ink as a function of time for different coated substrates,

FIG. 4 shows print sharpness (line thickness) on white background for different coated substrates,

FIG. 5 shows print sharpness (line thickness) on yellow background for different coated substrates,

FIG. 6 shows print sharpness (feathering) on white background for different coated substrates,

FIG. 7 shows print sharpness (feathering) on yellow background for different coated substrates,

FIG. 8 shows print sharpness (blurriness) on white background for different coated substrates,

FIG. 9 shows print sharpness (blurriness) on yellow background for different coated substrates,

FIG. 10 shows print density with cyan ink for different coated substrates,

FIG. 11 shows print density with black ink for different coated substrates, and

FIG. 12 shows a scanning electron microscopy image of an ink-receptive coated substrate according to an embodiment of the invention.

### DETAILED DESCRIPTION OF EMBODIMENTS OF THE INVENTION

The formulation according to an embodiment of the present invention comprises more than 1 wt. % of dry matter of a mesoporous material comprising particles, or agglomerates, of precipitated silica, wherein the mesoporous material is in the form of a Quartzene® material of CMS type, which can be written as (Ca_{0.35},Mg_{0.65})O×3.35 SiO₂, i.e. Me=(Ca_{0.35},Mg_{0.65}), y=1 and m=3.35. The mesoporous material is incorporated in the formulation in the form of a paste having a water content within a range of 60-95 wt. %, wherein the paste has been obtained by washing and dewatering of a slurry formed by mixing alkali silicate with a salt solution so that coagulation occurs.

The mesoporous material is formed as a precipitate by mixing alkali silicate with a salt solution. The precipitate is thereafter processed in various ways to obtain an end product having desired properties in terms of pore size, particle size, surface area, density, etc. The amorphous precipitated silica material used for the formulation according to embodiments of the invention has a mesoporous structure with a BET surface area of at least 200 m²/g, at least 300 m²/g or at least 400 m²/g.

The mesoporous material may be prepared in accordance with the method described in WO 2006/071183, wherein calcium and magnesium sources are added to a dilute active aqueous sodium silicate solution. A salt solution comprising MgCl₂ and CaCl₂) is prepared at a ratio of e.g. 68 mol % Mg and 32 mol % Ca. In the present case, the 1.5 M (with respect to SiO₂) sodium silicate solution is preferably mixed into the salt solution, and the resulting mixture is agitated at room temperature. Subsequent coagulation occurs and the slurry formed is thereafter washed and dewatered on a filter belt by means of vacuum suction to become a paste.

### Examples

A pre-coating formulation comprising an inorganic filler in the form of calcium carbonate (CaCO₃, HC90 from Omya), a binder in the form of styrene-butadiene (S/B) latex (HPB 70 from Trinseo), and carboxymethyl cellulose (CMC, Finnfix 5 from CP Kelco) was prepared. A mesoporous material comprising particles of precipitated silica, Quartzene® CMS from Svenska Aerogel AB, prepared according to the above description, was thereafter added to the pre-coating formulation in the form of a paste and in the form of a powder, respectively, to form final formulations. The CMS in paste form had a BET surface area of 260 m²/g.

First, a pre-coating formulation (Ref) was prepared. Calcium carbonate (dry content 78.1 wt. %) and S/B latex (dry content 52.6 wt. %) were mixed by mechanical stirring for 10 minutes. Thereafter, CMC was added and the resulting mixture was mechanically stirred for 20 minutes before an addition of a minor amount of water was made. The relative amounts of the different constituents are in Table I shown in terms of pph, i.e. parts per hundred parts of filler.

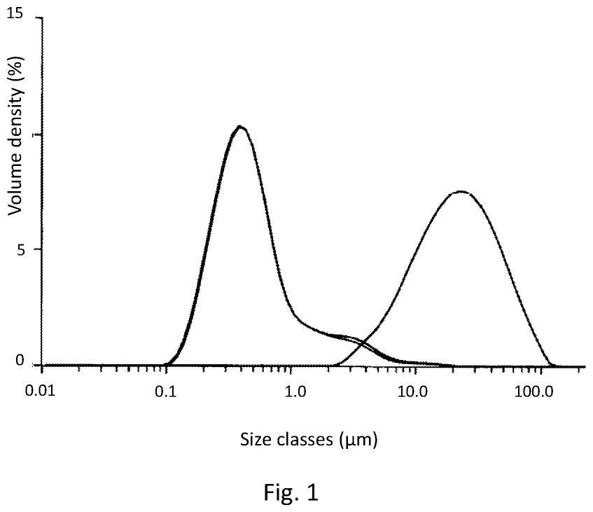

In the preparation of formulations comprising precipitated silica, Quartzene® CMS was added to the pre-coating formulation in two different forms, on one hand in the form of a paste with a water content of 93 wt. % and on the other hand in the form of a dry powder having a density of 70 kg/m³. Each of the paste and the powder were added to the pre-coating formulation in amounts of 1 wt. % and 5 wt. % of dry matter, see Table I. Furthermore, a formulation comprising the paste in an amount of 3 wt. % of dry matter was prepared. Prior to adding the paste to the formulation, the paste was ultrasound treated for about 1 hour to reduce the particle size. The particle size distributions of ultrasound treated paste and untreated paste are shown in FIG. 1. As can be seen, the ultrasound treatment reduces the particle size such that the D50 value of the particle size distribution is 0.4 μm and the D90 value is 1.7 μm, compared to D50=21 μm and D90=54 μm of untreated paste.

After adding all constituents, water was added in an amount required to reach a desired viscosity.

All the formulations were prepared with different dry matter content to achieve the same viscosity, see table I.

TABLE I

| | | | | Silica | Silica | Dry |
|---|---|---|---|---|---|---|
| | CaCO₃ | Latex | CMC | paste | powder | content |
| Formulation | (pph) | (pph) | (pph) | (wt. %) | (wt. %) | (wt. %) |
| Ref | 100 | 8 | 1 | — | — | 73.9 |
| Powder1 | 100 | 8 | 1 | — | 1 | 67.9 |
| Powder5 | 100 | 8 | 1 | — | 5 | 70.0 |
| Paste1 | 100 | 8 | 1 | 1 | — | 67.5 |
| Paste5 | 100 | 8 | 1 | 5 | — | 51.1 |

A laboratory drawdown coater with rods at different sizes was used for lab coating.

Cardboard substrates (200 g/m²) and polyester film substrates (Mylar) were coated with the formulations listed in Table I. The weights of the coatings are listed in Table II.

TABLE II

| | Coating weight on | Coating weight on |
|---|---|---|
| Formulation | cardboard (g/m²) | polyester (g/m²) |
| Ref | 8.6 | 7.98 |
| Powder1 | 9.4 | 12.0 |
| Powder5 | 20.5 | 13.2 |
| Paste1 | 13.4 | 15.9 |
| Paste5 | 13.8 | 11.0 |

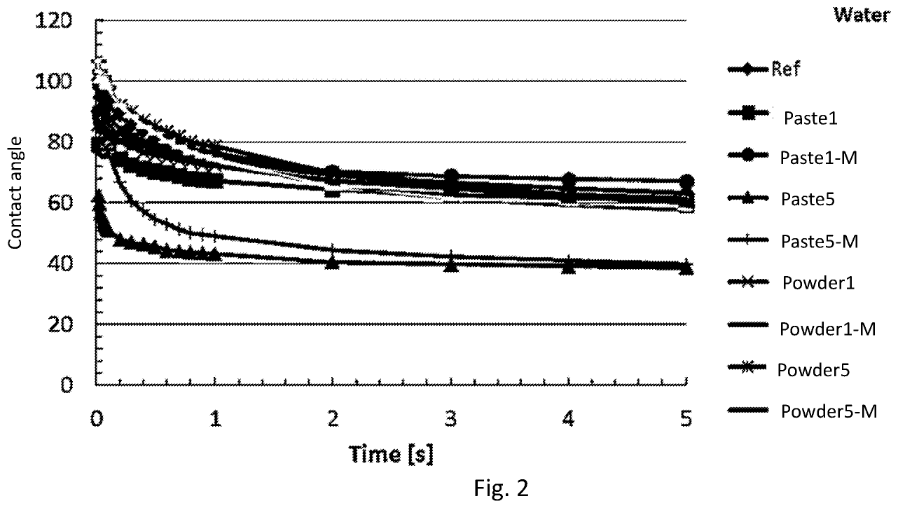

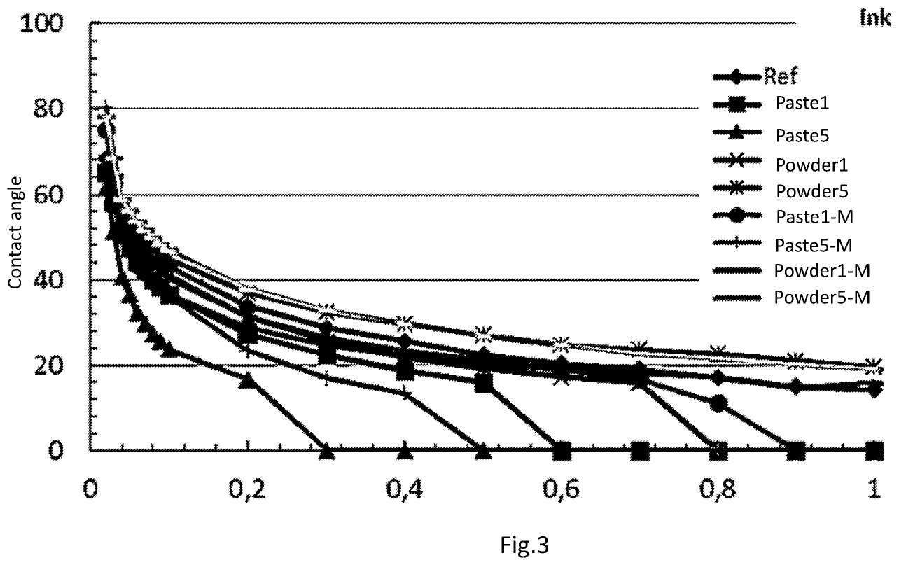

The contact angles of water and dye based cyan ink, respectively, on the coated substrates were measured as a function of time after placing a droplet of the respective liquid on the coated substrate. The results are shown in FIGS. 2 and 3, respectively, wherein an M after the sample name indicates that the coated substrate was a polyester substrate (Mylar). As can be seen, the addition of 5 wt. % of mesoporous material in the form of a paste (Paste5 and Paste5-M) significantly speeds up the contact angle reduction over time for both water and ink, thus indicating that the liquids diffuse faster into the surface, accelerating the drying process. The faster reduction in contact angle is seen for both types of substrates. For cyan ink, a slightly faster reduction is also seen for 1 wt. % of mesoporous material in the form of a paste (Paste1 and Paste1-M). The faster drying process will contribute to a higher productivity without impairing printing quality. Alternatively, it is possible to improve the printing quality without reducing productivity.

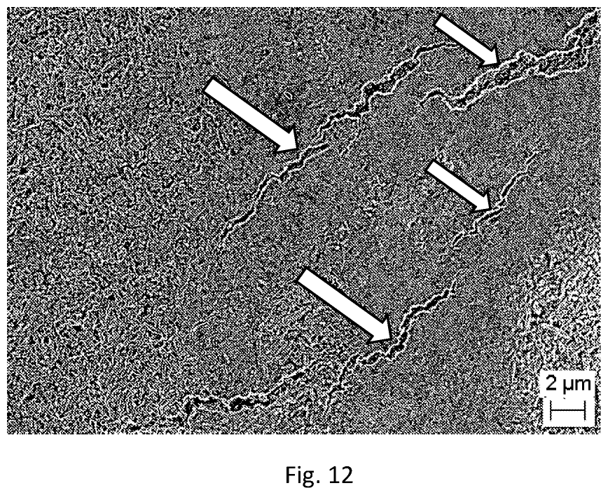

Observations using light optical microscopy and scanning electron microscopy (SEM) indicate that microcracks having a width of the order 1 μm are present on the substrates coated with the formulation Paste5 comprising 5 wt. % of mesoporous material and on substrates coated with the formulation comprising the paste in the amount of 3 wt. % of dry matter. It was observed that the larger amount of mesoporous material (5 wt. %) resulted in a larger amount of microcracks than the smaller amount of mesoporous material (3 wt. %). FIG. 12 shows an SEM image of the cardboard substrate coated with the formulation comprising the paste in the amount of 3 wt. % of dry matter, on which the microcracks have been indicated by arrows. No microcracks were observed on the other substrates.

Test printing was performed using Canon CLI-42×8 printing ink, which is a dye based ink.

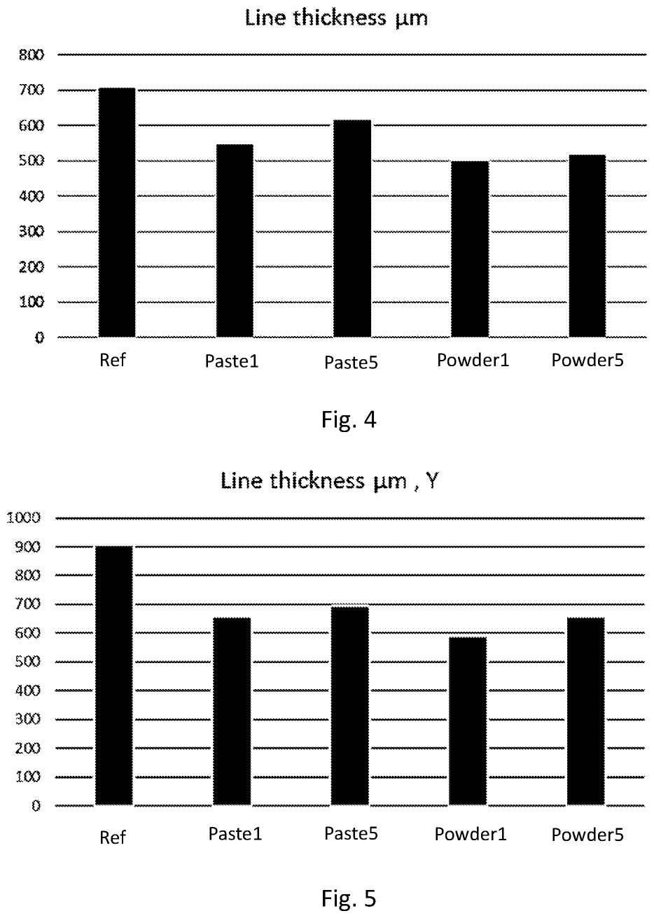

The print sharpness in terms of thickness of a printed black line on white and on yellow backgrounds, respectively, was determined for the different samples. Results are shown in FIGS. 4 and 5, respectively. The line thickness is significantly reduced with all formulations comprising mesoporous material both on white background (FIG. 4) and on yellow background (FIG. 5).

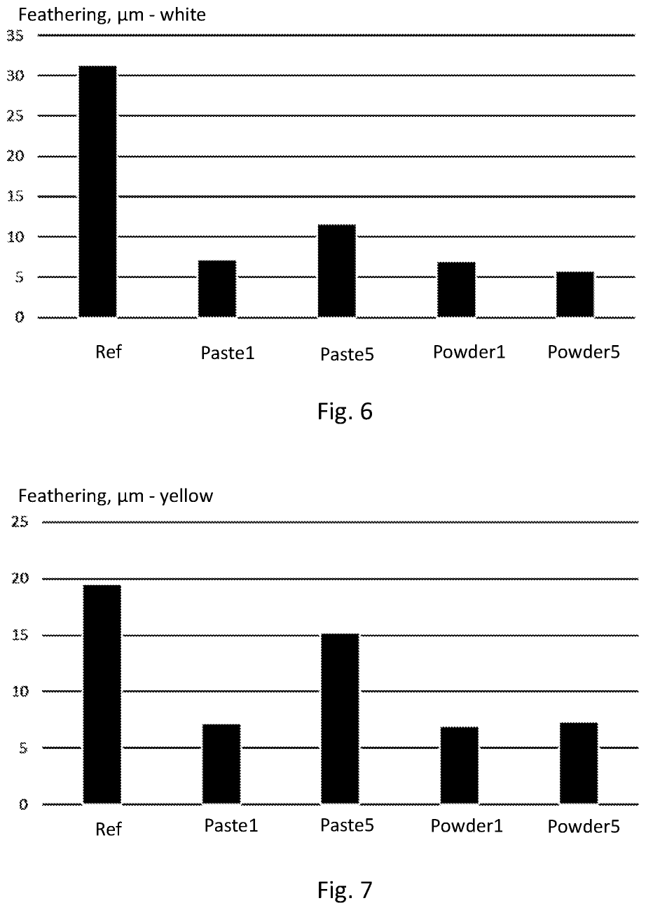

The print sharpness in terms of small scale variations on the line perimeter, so called feathering, was also determined for the different samples. The results are in FIGS. 6 and 7 shown as the standard deviation in μm of the local distance differences between a straight line and the perimeter for a black line on white and yellow backgrounds, respectively. Again, addition of mesoporous material reduces the standard deviation significantly, thereby improving the print sharpness, both on white and on yellow background.

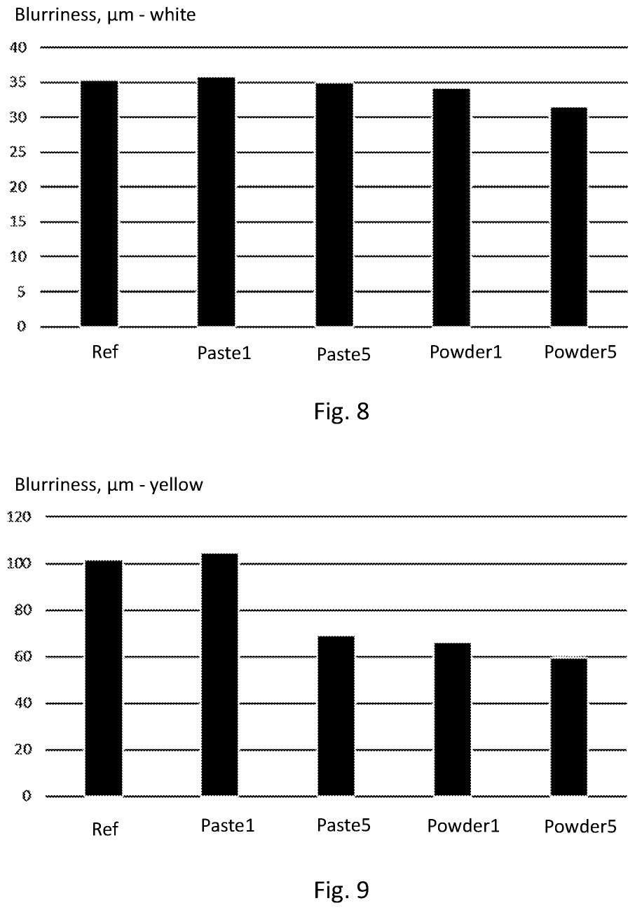

Also the blurriness, i.e. the unsharpness of line edge gradients, was determined for the different samples. The results are in FIGS. 8 and 9 shown as the local distance differences in μm between the edges from two different thresholds used on the object. The blurriness was slightly reduced with the addition of mesoporous material in the formulation, in particular on yellow background in which case the improvement is significant.

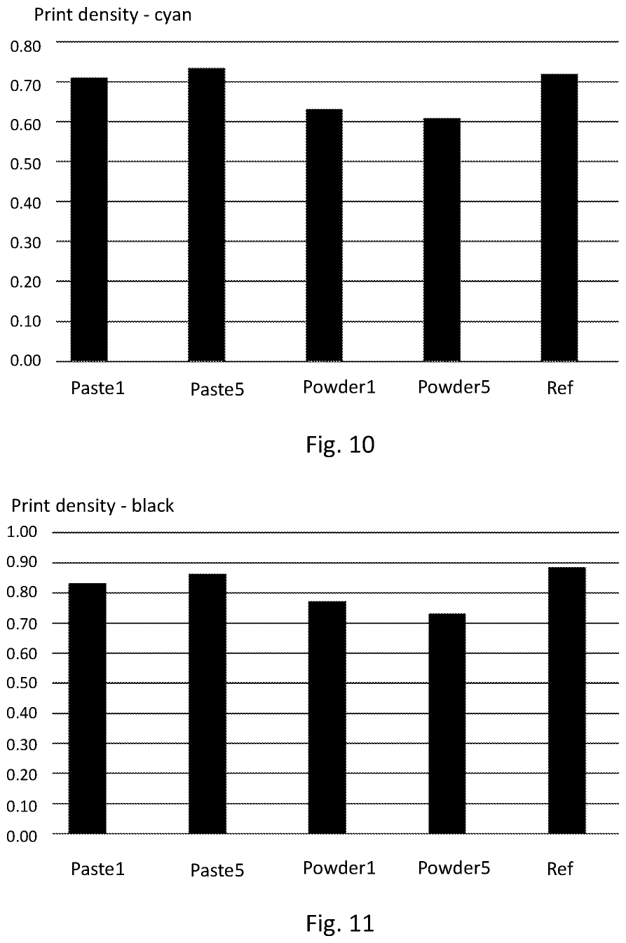

Furthermore, the print density was determined both for cyan ink and for black ink. The results are shown in FIGS. 10 (cyan ink) and 11 (black ink), respectively. As can be seen, the print density (indicated in log₁₀1/Reflectance) is affected for the substrates coated with the formulations containing mesoporous material. However, the formulation Paste5 containing 5 wt. % of mesoporous material in the form of a paste affects print density the least (a reduction of less than 0.05). Since a reduction of 0.1 in print density is visible to the human eye, it is desirable that the impact on print density is minimal. Mesoporous material in powder form, although improving print sharpness, has a relatively large negative impact on print density when compared to the reference sample.

To summarize, of the tested samples, the samples containing 5 wt. % of mesoporous material added in the form of a paste show the least reduction in print density in comparison with a reference sample, significant improvements in print sharpness and the fastest reduction in contact angle over time. This indicates that a formulation according to this embodiment provides rapid adsorption of ink with improved printing quality and increased productivity, without significantly impairing printing density.

The invention is of course not in any way restricted to the embodiments described above. On the contrary, many possibilities to modifications thereof will be apparent to a person with ordinary skill in the art without departing from the basic idea of the invention such as defined in the appended claims.

1. A formulation for forming an ink-receptive coating on a substrate, wherein the formulation comprises more than 1 percent by weight (wt. %) of dry matter of a mesoporous material comprising particles of precipitated silica, wherein the mesoporous material is incorporated in the formulation in the form of a paste having a water content within a range of 60-95 wt. %, wherein the paste has been obtained by washing and dewatering of a slurry formed by mixing alkali silicate with a salt solution so that coagulation occurs.

2. The formulation according to claim 1, wherein the mesoporous material is present in the formulation in an amount of 2-15 wt. % of dry matter, preferably in an amount of 3-12 wt. %, more preferably in an amount of 4-10 wt. %.

3. The formulation according to claim 1, wherein the particles of precipitated silica correspond to the formula Me_{y}O×m SiO₂, wherein Me denotes any two or more metals selected among Ca, Mg, Cu, Zn, Mn, Cd, Pb, Ni, Fe, Cr, Al, Ti, V, Co, Mo, Sn, Sb, Sr, Ba and W, y denotes the molar ratio of metallic constituents to oxygen, and m denotes the molar ratio of SiO₂/Me_{y}O.

4. The formulation according to claim 3, wherein Me denotes Ca and/or Mg.

5. The formulation according to claim 1, wherein the paste has a water content within a range of 70-95 wt. %.

6. The formulation according to claim 1, wherein a particle size distribution of the particles of precipitated silica has a particle size D90 value of less than 5 preferably of less than 3 μm and more preferably of less than 2 μm.

7. The formulation according to claim 6, wherein the particle size distribution has a particle size D50 value of less than 1 preferably of less than 0.5 μm and more preferably of less than 0.45 μm.

8. The formulation according to claim 1, further comprising:
an inorganic filler,
a binder in the form of a polymer,
a thickener, and
optionally one or more additives selected among dispersants, antifoaming agents, biocides, co-binders and colorants.

9. The formulation according to claim 8, wherein the binder is present in an amount of 2-20 wt. % of dry matter.

10. The formulation according to claim 8, wherein the thickener is present in an amount of 0.5-5 wt. % of dry matter.

11. The formulation according to claim 8, wherein the inorganic filler is present in an amount of 75-95 wt. % of dry matter.

12. An ink-receptive coated substrate, comprising:
a substrate, and
an ink-receptive coating formed on the substrate, wherein the coating has been formed by applying the formulation according to claim 1 onto a surface of the substrate.

13. The ink-receptive coated substrate according to claim 12, wherein the coating comprises microcracks having a width of less than 10 μm, preferably of less than 5 μm, more preferably of less than 3 μm.

14. The ink-receptive coated substrate according to claim 12, wherein the coating is present on the substrate in an amount of 1.0-20 g/m², preferably 1.0-15 g/m², more preferably 1.5-12 g/m².

15. A method of forming an ink-receptive coated substrate, comprising:
providing a substrate, and
forming an ink-receptive coating on the substrate by applying the formulation according to claim 1 onto a surface of the substrate and subsequently drying the applied formulation.

16. A method comprising using the formulation according to claim 1 for forming an ink-receptive coating on a substrate.

17. The formulation according to claim 2, wherein the particles of precipitated silica correspond to the formula Me_{y}O×m SiO₂, wherein Me denotes any two or more metals selected among Ca, Mg, Cu, Zn, Mn, Cd, Pb, Ni, Fe, Cr, Al, Ti, V, Co, Mo, Sn, Sb, Sr, Ba and W, y denotes the molar ratio of metallic constituents to oxygen, and m denotes the molar ratio of SiO₂/Me_{y}O.

18. The formulation according to claim 2, wherein the paste has a water content within a range of 70-95 wt. %.

19. The formulation according to claim 3, wherein the paste has a water content within a range of 70-95 wt. %.

20. The formulation according to claim 4, wherein the paste has a water content within a range of 70-95 wt. %.
